(19) United States
(12) Patent Application Publication
(10) Pub. No.: US 2017/0065132 A1
(43) Pub. Date: Mar. 9, 2017

(54) BATHTUB APPLIQUE

(71) Applicant: Fancy Tub, LLC, Arroyo Grande, CA (US)

(72) Inventor: Amber Lindsay Wighton, Arroyo Grande, CA (US)

(21) Appl. No.: 15/257,006

(22) Filed: Sep. 6, 2016

Related U.S. Application Data
(60) Provisional application No. 62/214,454, filed on Sep. 4, 2015.

(51) Int. Cl. A47K 3/16; B32B 27/40; B32B 7/12; B32B 7/06; A47K 3/00; B32B 5/18

(52) U.S. Cl. CPC A47K 3/16; A47K 3/001; B32B 5/18; B32B 7/12; B32B 7/06; B32B 27/40; B32B 2255/102; B32B 2266/0278

(57) ABSTRACT

A bathtub applique including a polyurethane panel, pressure sensitive adhesive, and release liner is described.

### CROSS-REFERENCE TO RELATED APPLICATIONS

Pursuant to 35 U.S.C. 119, the present application claims priority to and incorporates by reference the entire contents of U.S. Provisional Patent Application Ser. No. 62/214,454 filed Sep. 4, 2015.

### BACKGROUND

A bathtub surround is a decorative furnishing for a bathtub. Bathtub surrounds are designed to match or enhance the décor of the bathtub or bathroom by covering an exposed area of a bathtub. Installation of a bathtub surround can be very time consuming and expensive.

Bathtub surrounds are built in place, generally at the time of installation of the bathtub, by a carpenter or other installation professional. Bathtubs can have flat outer surfaces, however, many bathtubs can have outer surfaces that are curved or otherwise contoured. Thus, installation can include fabrication of a framework for the surround to be built on. The framework can include layers of particle board upon which the wooden surround is attached. Saws and other power tools are usually required for installation.

If one desires installation of a bathtub surround after installation of the tub, for example, during a bathroom remodel, existing tile and molding must be removed. Surfaces from which the tile and molding have been removed require preparation. Additionally, particle board or other parts of a framework may need to be built. A carpenter then fabricates the surround to cover the tub. Power tools are used to remove existing materials and to fabricate the surround. The entire process can be very messy and disruptive.

Additionally, since bathtub surrounds are made of wood, the exposed surfaces and joints must be sealed. Water that seeps through the wood can cause mold to form behind the surround or warping and deterioration of the surround. The owner must maintain the surfaces and joints to prevent water damage.

Currently, prefabricated shower surrounds can be purchased, however shower surrounds are designed to cover walls above a bathtub or around a shower. Prefabricated shower surrounds are made of compression molded fiberglass, polystyrene, acrylic, acrylic-capped ABS plastic, or other rigid materials. Installation requires removal of existing materials and preparation of the surfaces by cleaning and priming. Fitting of the shower surround is done by cutting with power tools. A solvent-based adhesive is applied to the walls and the shower surround panels are attached to the wall while aligning the panel with the tub and any previously attached panels. Once the panels are in place, the adhesive is allowed to dry, and the joints and edges are sealed with caulking material.

In addition to having an industrial appearance, difficulties can arise when installing shower surrounds. Shower surrounds may fail to adhere properly to a surface if there is insufficient adhesive, the adhesive isn't allowed to dry properly, or if the surface the shower surround adheres to isn't flat. Use of too much adhesive results in adhesive oozing out from between the seams and edges requiring cleanup. Additionally, the liquid adhesive can run and cover surfaces not intended to be covered with adhesive which also requires cleanup. Since the adhesive is solvent-based, simple cleanup with water is not possible.

### SUMMARY

The present invention is embodied in a generally rectangular bathtub applique having a panel with a planar surface and a non-planar surface. A layer of adhesive adheres to and covers the planar surface. A release liner is releasably adhered to an outer surface of the adhesive. The adhesive includes a permanent adhesive and the panel is made of waterproof materials.

In other, other embodiments of the invention, the panel includes polyurethane. In still other embodiments of the invention, the polyurethane is a cured mixture of a polyol, an isocyanate, a surfactant, and a crosslinker. In yet other embodiments of the invention, the panel has a thickness of between about ¼ inches and 2 inches.

In other embodiments of the invention, the layer of adhesive includes a permanent pressure sensitive adhesive having holding capacity greater than 24 hours, stripping force greater than 1 kg/inch, and initial adhesion less than 3.0 cm. In still other embodiments of the invention, the permanent pressure sensitive adhesive is a solvent-based acrylic adhesive. In yet other embodiments of the invention, the layer of adhesive is between about 1/16 inches and about ¼ inches thick. In still other embodiments of the invention, the permanent pressure sensitive adhesive includes 10-15% acrylic ester and 28-35% chlorinated rubber. In yet other embodiments of the invention, the generally rectangular panel, the layer of adhesive, and the release liner can be cut with a utility knife.

Other features of the invention should become apparent to those skilled in the art from the following description of the preferred embodiment(s) taken in conjunction with the accompanying drawings, which illustrate, by way of example, the principles of the invention, the invention not being limited to any particular preferred embodiment(s) disclosed.

### BRIEF DESCRIPTION OF THE DRAWINGS

These and other features, aspects, and advantages of the present invention will become better understood with reference to the following description, appended claims, and accompanying drawings, where:

FIG. 1 is a side elevation view of a bathtub applique according to a first embodiment.

FIG. 2 is a front perspective view of the bathtub applique shown in FIG. 1.

FIG. 3 is a top elevation view a panel of the bathtub applique shown in FIG. 1 being flexed or bent.

FIG. 4 is a flowchart of a method to fabricate the bathtub applique shown in FIG. 1.

FIG. 5 is a flowchart of a method to install the bathtub applique shown in FIG. 1.

Unless otherwise indicated, the illustrations in the above figures are not necessarily drawn to scale.

### DETAILED DESCRIPTION OF THE PREFERRED EMBODIMENTS

All of the features disclosed in the specification, including the claims, abstract, and drawings, and all of the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise. Thus, unless expressly stated otherwise, each feature disclosed is one example only of a generic series of equivalent or similar features.

A first embodiment of a bathtub applique 100 is shown in FIG. 1. Bathtub applique 100 is also known as a bathtub overlay. Bathtub applique 100 includes a panel 110, a layer of adhesive 120, and liner sheet 130. Panel 110 includes an outer surface 112 and an inner surface 114. Layer of adhesive 120 includes an outer surface 122.

Referring to FIG. 2, surface 114 of panel 110 is generally planar so that it mates with the surface to which it will be adhered. Surface 112 of panel 110 can include generally planar areas 116 and non-planar areas 118. Additionally, surface 112 can be embossed or patterned, for example, faux wood grained.

Panel 110 is generally rectangular having dimensions that can vary. The term “generally rectangular” as used herein means all corners 102 are approximately 90 degrees and opposite sides 104, 106 are approximately parallel. The meaning of generally rectangular includes corners 102 that are chamfered, beveled, rounded, or similarly modified. Height H can range from about 12 inches to about 24 inches. Width W can range from about 48 inches to about 84 inches. In one embodiment, panel 110 has dimensions of about 13.75 inches×about 60 inches. In another embodiment, panel 110 has dimensions of about 15 inches×about 60 inches. In yet another embodiment, panel 110 has dimensions of about 18 inches×about 60 inches. Other dimensions can be fabricated to fit and adhere to larger- or smaller-sized bathtubs or surfaces. Additionally, panel 110 can be cut to fit non-rectangular areas.

Referring back to FIG. 1, because outer surface 112 of panel 110 can be non-planar, embossed, or patterned, thickness Tₚ can vary. Thickness Tₚ can range from about ¼ inches to about 2 inches. In particular, in non-planar areas 118, thickness Tₚ can range from ¼ inches to about 2 inches, while in planar areas 116, thickness Tₚ can range from about ¼ inches to about 1 inch or less. The minimum thickness Tₚ of panel 110 depends on the material it is made from. In practice, the minimum thickness Tₚ is sufficient such that panel 110 is self-supporting so that it is not easily folded upon itself, however, some flexibility allows the applique 100 to conform to non-planar tub surfaces and liner sheet 130 to be easily removed as the panel is being applied to the surface of a bathtub.

Panel 110 can be formed from a variety of waterproof materials designed to prevent water from penetrating into panel 110. Suitable materials include plastics, polyethylene, polypropylene, and other polyolefins, polyvinyl chloride (PVC), acrylonitrile butadiene (ABS), polyurethanes, rubber or synthetic rubber, wood, etc. One particularly suitable material is polyether-based polyurethanes which may be antimicrobial. Materials that are inherently not waterproof, for example, wood veneer, can be coated with a waterproof sealant such as a polyurethane coating. Thermoplastic or thermosetting materials are formed into a panel using appropriately sized and shaped molds. Alternatively, materials can be formed from sheets by cutting to size and shape. To aid installers of bathtub applique 100, materials used to form panel 110 are chosen to be easily cut with utility knives.

Additionally, the materials panel 110 can be made from are chosen to be flexible. FIG. 3 shows panel 110 being flexed 180 degrees without cracking or breaking. Radius of curvature R is between about 2 inches and about 4 inches. Flexibility in panel 110 allows bathtub applique 100 to adhere to surfaces that are non-planar or curved. One of ordinary skill in the art would recognize that radii of curvature greater than about 4 inches may also be used.

Adhesive layer 120 is made of permanent pressure sensitive adhesives. Permanent adhesives are designed to hold panel 110 in place under normal use conditions. Permanent adhesives make it very difficult to remove panel 110. If panel 110 is removed by pulling it away from the bathtub, a permanent adhesive has sufficient holding power that damage to the panel occurs or adhesive residue remains. Examples of permanent adhesives are found in VHB™ brand tapes (3M Corporation, St. Paul, Minn.).

Pressure sensitive adhesives are characterized as being viscoelastic. This characteristic gives pressure sensitive adhesives a permanently tacky property, allowing the adhesive to adhere to a substrate when pressed against it. Pressure sensitive adhesives can be solvent-based, emulsion- or water-based, or hot melt adhesives. Additionally, pressure sensitive adhesives can be classified as acrylic-based, rubber-based, or silicone-based.

Adhesive layer 120 can be applied to inner surface 114 of panel 110 in a number of ways. The adhesive layer can be coated directly onto inner surface 114. If the adhesive is solvent- or emulsion-based, it is allowed to dry or cure before covering the adhesive layer's outer surface 122 with liner sheet 130. Alternatively, the adhesive layer 120 can be coated onto liner sheet 130, dried or cured, and pressed onto inner surface 114 of panel 110. Depending on the material panel 110 is made of, inner surface 114 can be roughened, either when molded or after, or a primer applied to enhance the bond strength between panel 110 and adhesive layer 120.

Thickness Tₐ of adhesive layer 120 ranges from about 1/16 inches to about ¼ inches. If adhesive layer 120 is too thin, outer surface 122 may fail to sufficiently contact the bathtub surface to provide permanent adhesion. If adhesive layer 120 is too thick, panel 110 can shift due to the elastic nature of the adhesive. In some embodiments, thickness Tₐ is ⅛ inches.

Outer surface 122 of adhesive layer 120 is covered with release liner 130. Release liner 130 is made of paper coated on surface 132 with a release material. Release liner 130 can be applied to adhesive layer 120 after the adhesive is coated and dried or cured on panel 110, or alternatively, adhesive layer 120 can be coated and dried or cured onto release liner 132 followed by application to panel 110.

The purpose of adhesive layer 120 is to adhere panel 110 to the surface of a bathtub or wall. The ability of an adhesive to adhere to a surface is determined by several properties that have been standardized by the Pressure Sensitive Tape Council (PSTC). Suitable adhesives for use in the adhesive layer 120 have holding capacity or shear values of more than 12 hours (PSTC-7), stripping force or peel adhesion greater than 1 kg/inch (PSTC-1), and initial adhesion or rolling ball tack of less than 5.0 cm (PSTC-6).

Surface 132 of release liner 130 is adjacent to outer surface 122 and includes a layer of release material. Release materials include silicones, waxes, polyfluorocarbons, carbamates, etc. The function of release material is to allow the liner to be easily removed from the adhesive surface 122 without tearing or damaging the liner 130 or removing adhesive from panel 110. Any release material that meets this requirement can be used. Suitable release liners 130 include, but are not limited to, liners from 3M Corporation, Loparex of Cary, N.C. and Rayven, Incorporated of St. Paul, Minn.

Surface 134 of release liner 130 can be unprinted or include printed indicia. The printed indicia can include instructions for how to apply bathtub applique 100, company information, aids for sizing the applique 100, or other indicia.

In some alternative embodiments, pigments and/or dyes can be included in panel 110 or adhesive layer 120 to impart color or opacity. Panel 110 and adhesive layer 120 can also include additives such as antioxidants, UV inhibitors, plasticizers, flame retardants, and other materials.

In other alternative embodiments, outer surface 112 of panel 110 can include coatings such as a primers, paints, stains, antibacterial coatings, etc. Outer surface 112 can include coverings such as laminates, veneers, films, etc. Any coatings or coverings used are to be waterproof or made to be waterproof.

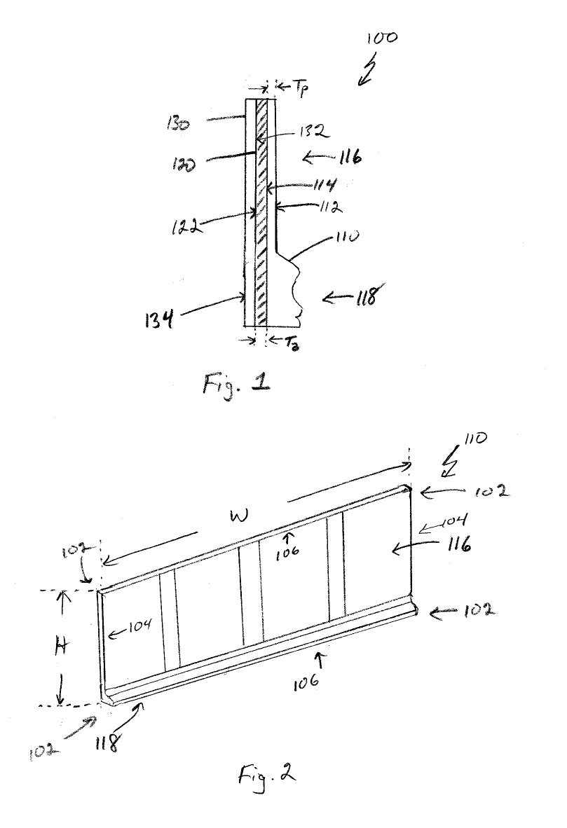

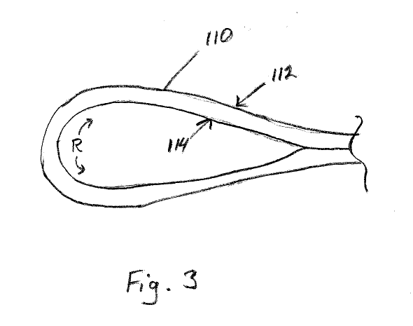

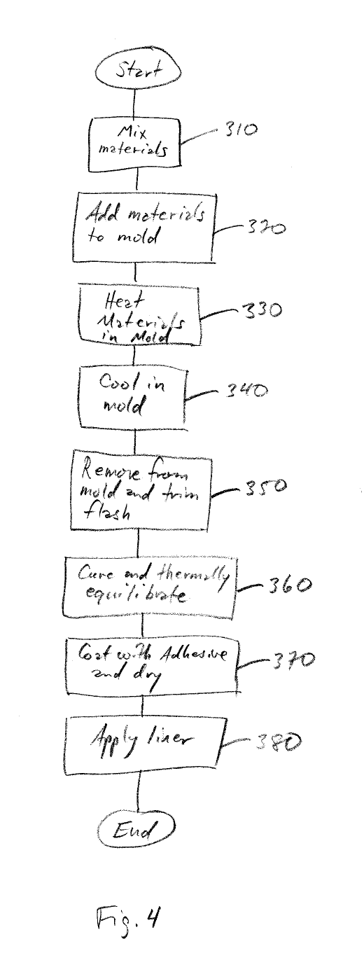

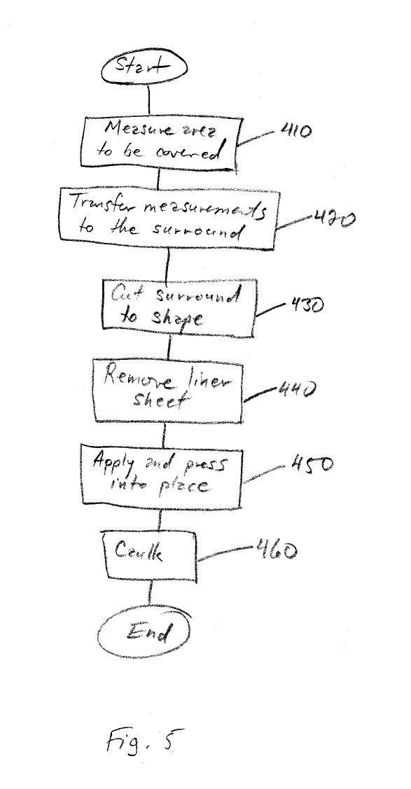

FIG. 4 is a flowchart of an embodiment to manufacture bathtub applique 100 using a mold. The mold can be made of any material that is heat resistant and permits the panel 110 to be easily removed. One suitable mold can be made of silicone rubber. Other suitable molds include those made of metals such as iron or steel, and metals that are coated with release material, such as silicone rubber. For panels 110 made of thermosetting materials, at step 310, reactive materials and catalysts are blended together along with desired additives and pigments. Blending can take place in mixing vats or materials can be blended together using in-line mixers as the reactive mixture is pumped or injected into the mold at step 320. Once the reactive mixture has filled the mold, it is heated in step 330 to cure. The mold and reactive mixture are heated for an hour or until the reactive mixture is set. After cooling at step 340, the molded panel 110 is removed from the mold in step 350 and excess material, such as flash or sprues, is trimmed from panel 110. At step 360, panel 110 is allowed to further cure and become thermally stable before being coated with an adhesive layer 120 and optionally painted at step 370. After the adhesive has dried, it is covered with release liner 130 in step 380.

For panels 110 made of thermoplastic materials, the flowchart in FIG. 4 can generally be followed. At step 310, materials along with desired additives and pigments are blended together. Blending can take place in a heated tank or the ingredients can be blended in an extruder and held in a heated hopper. The blend is pumped or injected into the mold at step 320. If the blending takes place in an extruder, the blend can be extruded directly into the mold at step 320. Since panel 110 is made of thermoplastic materials, step 330 is unnecessary. The material in the mold is allowed to cool at step 340 before being removed from the mold and trimmed at step 350. At step 360, the panel 110 is allowed to become thermally stable before being coated with an adhesive layer 120 at step 370. After the adhesive layer 120 has dried, it is covered with release liner 130 in step 380.

In one embodiment, a liquid mixture of 47% polyoxyethylene-polyoxypropylene block copolymer (polyol), 50% polymethylene polyphenyl isocyanate (PMDI), and 2% organosilicon surfactant are mixed in a tank. 1% of a catalyst is added and the liquid reactive mixture is injected into a mold. In some embodiments, crosslinkers, for example, glycerol, trimethylolpropane, pentaerythritol, triallyl isocyanurate (TAIC), etc., may be added to the reactive mixture. In other embodiments, foaming or blowing agents, for example, isocyanurates and water, carbon dioxide, etc. may be added to the reactive mixture. In some embodiments, chain extenders, for example, ethylene glycol, diethylene glycol, propylene glycol, 1,3-propanediol, ethanolamine, etc., may be added to the reactive mixture. The mold and liquid reactive mixture are heated for approximately 1 hour to cure the liquid mixture to solid polyurethane. The mold is then allowed to cool and the panel is removed from the mold. In this manner, a single mold can produce 20 cured panels per day. After removal from the mold, any flash or sprues are removed.

The panel is allowed to further cure for about 24 hours before being painted and then coated with a layer of solvent-based acrylic pressure sensitive adhesive. The adhesive is a mixture of 10-15% acrylic ester, 25-30% organic solvent, 28-35% chlorinated rubber, and 8-15% ethyl acetate from Huxiao Chemical (Ningbo, China). Acrylic esters include polymers and copolymers that include alkyl acrylates, alkyl methacrylates, acrylic acid, methacrylic acid, alkyl fumarates, alkyl maleates, etc. Chlorinated rubber includes chlorinated polyethylenes (CPE), polypropylenes (CPP), butyl rubbers, ethylene propylene diene monomer rubbers (chlorinated EPDM), and other rubbers. Organic solvents include aromatic and aliphatic hydrocarbons such as toluene, xylene, hexane, heptane, etc., esters such as ethyl acetate, butyl acetate, etc., and others. In another embodiment, the adhesive is a mixture of 10-15% acrylic ester, 25-30% organic solvent, 28-35% polyvinyl acetate (PVA), and 8-15% ethyl acetate.

The adhesive is coated to achieve a dried adhesive layer thickness of about ⅛ inches. Adhesive properties include holding capacity greater than 24 hours, stripping force greater than 1 kg/inch, and initial adhesion less than 3.0 cm. After drying, a paper-based release liner is applied to cover and protect the outer surface of the adhesive layer. The outer surface of the release liner is printed with ruler markings.

FIG. 5 is a flowchart of an embodiment to install bathtub applique 100. In step 410, the area to be covered is measured. Depending on how the bathtub is installed, the measurement from wall-to-wall, end-to-end of the bathtub, or wall-to-end of bathtub is taken. If the applique 100 will abut baseboards, the baseboard-to-baseboard or baseboard-to-end of tub measurement is also taken, as well as the height of the baseboard. In step 420, using the ruler guide printed on the liner sheet or a straightedge and tape measure, the measurements are transferred onto the applique 100, taking care to mark the measurements at the proper location on the applique 100. Alternatively, the measurements can be placed on the outer surface 112 of the applique 100.

At step 430, the bathtub applique 100 is cut to shape along the measured lines using a utility knife. Due to the thickness of the applique 100, several passes of the utility knife may be needed to cut the applique 100 to shape. Notches for the baseboards are cut out in a similar manner, as well as any cutouts for fixtures that may be needed. The applique 100 can be put in place to check for fit and additional trimming can be done. At step 440, the liner 130 is removed and the applique 100 is guided into position. At step 450, the applique 100 is pressed firmly into place, allowing the adhesive layer 120 to contact the surface of the area to be covered. The applique 100 is pressed firmly in all locations to ensure good contact of the adhesive layer 120 with the surface. Once the applique 100 is in place, at step 460, all the edges can be caulked with silicone or other waterproof caulking. The bathtub applique 100 is usable after the caulking has dried.

In some embodiments, steps 440 and 450 can be combined into a single step. The liner sheet 130 can be partially removed from a portion of the bathtub applique 100. The portion of applique 100 with exposed adhesive layer 120 can be pressed in place. The liner sheet 130 can then be removed by pulling it from the applique 100, while pressing the applique 100 in place.

The foregoing detailed description of the present invention is provided for purposes of illustration, and it is not intended to be exhaustive or to limit the invention to the particular embodiments disclosed. The embodiments may provide different capabilities and benefits, depending on the configuration used to implement the key features of the invention. Accordingly, the scope of the invention is defined only by the following claims.

I claim:

1. A bathtub applique comprising:
a generally rectangular panel having a planar first surface and a non-planar second surface;
a layer of adhesive adhered to and covering the planar first surface, the layer of adhesive having an outer surface; and
a release liner releasably adhered to the outer surface of the layer of adhesive;
wherein:
the layer of adhesive includes a permanent adhesive, and
the panel is made of waterproof materials.

2. The bathtub applique of claim 1, wherein the generally rectangular panel includes polyurethane.

3. The bathtub applique of claim 2, wherein the polyurethane is a cured mixture including a polyol, an isocyanate, and a surfactant.

4. The bathtub applique of claim 2, wherein the cured mixture further includes an ingredient selected from the group consisting of crosslinkers, foaming agents, chain extenders.

5. The bathtub applique of claim 1, wherein:
the generally rectangular panel has a thickness; and
the thickness is between about ¼ inches and about 2 inches.

6. The bathtub applique of claim 1, wherein the generally rectangular panel has a radius of curvature greater than about 2 inches.

7. The bathtub applique of claim 1, wherein the layer of adhesive includes a permanent pressure sensitive adhesive.

8. The bathtub applique of claim 7, wherein the permanent pressure sensitive adhesive has holding capacity greater than 24 hours, stripping force greater than 1 kg/inch, and initial adhesion less than 3.0 cm.

9. The bathtub applique of claim 7, wherein the permanent pressure sensitive adhesive is a solvent-based acrylic adhesive.

10. The bathtub applique of claim 9, wherein:
the layer of adhesive has a thickness; and
the thickness of the layer of adhesive is between about 1/16 inches and about ¼ inches.

11. The bathtub applique of claim 10, wherein the permanent pressure sensitive adhesive includes 10-15% acrylic ester and 28-35% chlorinated rubber.

12. The bathtub applique of claim 1, wherein the generally rectangular panel, the layer of adhesive, and the release liner can be cut with a utility knife.
